(19) United States
(12) Patent Application Publication
(10) Pub. No.: US 2010/0309413 A1
(43) Pub. Date: Dec. 9, 2010

(54) Reflective-type color display devices using polymer dispersed liquid crystals and dyes

(75) Inventors: Jae-eun Jang, Seoul (KR); Seung-nam Cha, Seoul (KR); Jae-eun Jung, Seoul (KR); Yong-wan Jin, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/654,711

(22) Filed: Dec. 30, 2009

(30) Foreign Application Priority Data
Jun. 9, 2009 (KR) 10-2009-0051061

(51) Int. Cl. G02F 1/1334

(52) U.S. Cl. 349/86

(57) ABSTRACT

Reflective-type color display devices using polymer dispersed liquid crystals (PDLCs) and dyes are provided, the display devices including a pixel unit having PDLC layers that are disposed between first electrodes and second electrodes. The PDLC layers have different color dyes. The first electrodes are disposed on a first substrate and the second electrodes are disposed on a second substrate, wherein the first and second substrates are apart from each other. The pixel unit includes different color sub pixels.

### CROSS-REFERENCE TO RELATED APPLICATIONS

This application claims the benefit of priority under 35 U.S.C. §119 from Korean Patent Application No. 10-2009-0051061, filed on Jun. 9, 2009, in the Korean Intellectual Property Office, the disclosure of which is incorporated herein in its entirety by reference.

### BACKGROUND

1. Field

Example embodiments relate to display devices. Other example embodiments relate to reflective-type color display devices using polymer dispersed liquid crystals (PDLC) and dyes.

2. Description of the Related Art

In general, cathode ray tube (CRT) monitors are used in televisions (TVs) and computers in order to display information. As screens increase in size and become slimmer, flat display devices (e.g., liquid crystal displays (LCDs), plasma display panels (PDPs) and field emission displays (FEDs)) are used. From among such flat display devices, much attention has been given to LCDs, which are mainly used as TVs and computer monitors due to low power consumption.

In general LCDs, an image is formed by passing white light generated by a back light unit through a polarizing plate and a liquid crystal layer and by passing the modulated white light through color filters. In such an LCD, only a part of white light generated by the back light unit is used to form an image due to use of the polarizing plate and the color filters, thereby increasing optical loss.

### SUMMARY

Example embodiments relate to display devices. Other example embodiments relate to reflective-type color display devices using polymer dispersed liquid crystals (PDLC) and dyes.

Additional aspects will be set forth in part in the description which follows and, in part, will be apparent from the description, or may be learned by practice of the presented example embodiments.

According to example embodiments there is provided a reflective-type color display device including a pixel unit having different color sub pixels, wherein the pixel unit includes a first substrate and a second substrate that are disposed apart from each other. The display device may include a plurality of first electrodes and a plurality of second electrodes that are respectively disposed on the first and second substrates, different color polymer dispersed liquid crystal (PDLC) layers that are disposed between the first electrodes and the second electrodes, and a reflective layer disposed on the first substrate. The PDLC layers may include different color dyes.

The first and second substrates may be transparent substrates. The first and second electrodes may be formed of a transparent conductive material. The reflective layer may be disposed on a bottom surface of the first substrate.

The different color dyes may be included in at least one selected from the group consisting of a polymer and liquid crystals.

The pixel unit may include a magenta sub pixel, a yellow sub pixel and a cyan sub pixel. The pixel unit may include a red sub pixel, a green sub pixel and a blue sub pixel.

According to example embodiments there is provided a reflective-type color display device including a pixel unit having different color sub pixels and a black and white sub pixel, wherein the pixel unit includes a first substrate and a second substrate that are disposed apart from each other. The display device may include a plurality of first electrodes and a plurality of second electrodes that are respectively disposed on the first and second substrates, different color polymer dispersed liquid crystal (PDLC) layers and a black PDLC layer that are disposed between the first electrodes and the second electrodes, and a reflective layer disposed on the first substrate. The different color PDLC layers include different color dyes and the black PDLC layer includes black dye.

The sub pixels of the pixel unit may be arranged in at least one line.

The pixel unit may include a magenta sub pixel, a yellow sub pixel, a cyan sub pixel, and the black and white sub pixel. The pixel unit may include a red sub pixel, a green sub pixel, a blue sub pixel, and the black and white sub pixel.

According to example embodiments, a reflective-type color display device includes a pixel unit having different color sub pixels and a black and white sub pixel, wherein the pixel unit includes a first substrate and a second substrate that are disposed apart from each other. The display device may include a plurality of first electrodes and a plurality of second electrodes that are respectively disposed on the first and second substrates, different color polymer dispersed liquid crystal (PDLC) layers and a PDLC layer that are disposed between the first electrodes and the second electrodes, and an absorption layer disposed on the first substrate. The different color PDLC layers include different color dyes.

According to example embodiments there is provide a reflective-type color display device including a pixel unit having six different color sub pixels, wherein the pixel unit includes a first substrate and a second substrate that are disposed apart from each other. The display device may include a plurality of first electrodes and a plurality of second electrodes that are respectively disposed on the first and second substrates, different color polymer dispersed liquid crystal (PDLC) layers that are disposed between the first electrodes and the second electrodes. The PDLC layers include different color dyes.

A reflective layer or an absorption layer may be disposed on an entire bottom surface of the first substrate.

The reflective layer may be disposed on a part of a bottom surface of the first substrate that corresponds to some pixels from among the six sub pixels, and the absorption layer may be disposed on another part of the bottom surface of the first substrate that corresponds to the other sub pixels.

According to example embodiments, there is provided a reflective-type color display device including a pixel unit having different color sub pixels, wherein the pixel unit includes a first substrate, a second substrate and a third substrate that are disposed apart from one another. The display device may include a plurality of first electrodes and a plurality of second electrodes that are respectively disposed on the first and second substrates, a plurality of third electrodes and a plurality of fourth electrodes that are respectively disposed on the second and third substrates, polymer dispersed liquid crystal (PDLC) layers disposed between the first and second electrodes, different color PDLC layers that are disposed between the third and fourth electrodes, and an absorption layer disposed on the first substrate. The PDLC layers include different color dyes.

According to example embodiments, there is a reflective-type color display device including a pixel unit having different color sub pixels, wherein the pixel unit includes a first substrate, a second substrate and a third substrate that are disposed apart from one another. The display device may include a plurality of first electrodes and a plurality of second electrodes that are respectively disposed on the first and second substrates, a plurality of third electrodes and a plurality of fourth electrodes that are respectively disposed on the second and third substrates, black polymer dispersed liquid crystal (PDLC) layers disposed between the first and second electrodes, different color PDLC layers that are disposed between the third and fourth electrodes, and a reflective layer disposed on the first substrate. The black PDLC layers include black dyes, and different color PDLC layers include different color dyes.

According to example embodiments, reflective-type color display devices may be manufactured at lower costs, in which an image is formed using polymer dispersed liquid crystals and dyes without having to use a polarizing plate and color filters. In reflective-type color display devices according to example embodiments, color reproduction is enhanced.

### BRIEF DESCRIPTION OF THE DRAWINGS

These and/or other aspects will become apparent and more readily appreciated from the following description of the embodiments, taken in conjunction with the accompanying drawings of which:

FIG. 1 is a plan view of a pixel unit included in a reflective-type display device according to example embodiments;

FIG. 2 is a cross-sectional view taken along a line II-II′ of FIG. 1;

FIGS. 3 to 5 are cross-sectional views illustrating a method of driving the reflective-type display device illustrated in FIGS. 1 and 2 according to example embodiments;

FIG. 6 is a plan view of a pixel unit included in a reflective-type display device according to example embodiments;

FIG. 7 is a cross-sectional view taken along a line VI-VI′ of FIG. 6;

FIGS. 8 to 11 are cross-sectional views illustrating a method of driving the reflective-type display device illustrated in FIGS. 6 and 7 according to example embodiments;

FIG. 12 is a cross-sectional view of a pixel unit included in a reflective-type display device according to example embodiments;

FIGS. 13 through 16 are cross-sectional views illustrating a method of driving the reflective-type display device illustrated in FIG. 12 according to example embodiments;

FIG. 17 is a plan view of a pixel unit included in a reflective-type display device according to example embodiments;

FIG. 18 is a plan view of a pixel unit included in a reflective-type display device according to example embodiments;

FIG. 19 is a cross-sectional view taken along a line A-A′ of FIG. 18;

FIG. 20 is a cross-sectional view taken along a line B-B′ of FIG. 18;

FIG. 21 is a plan view of a pixel unit included in a reflective-type display device according to example embodiments;

FIG. 22 is a cross-sectional view taken along a line C-C′ of FIG. 21;

FIG. 23 is a cross-sectional view taken along a line D-D′ of FIG. 21;

FIG. 24 is a cross-sectional view of a pixel unit included in a reflective-type display device according to example embodiments;

FIGS. 25 and 26 are cross-sectional views illustrating a method of driving the reflective-type display device illustrated in FIG. 24 according to example embodiments;

FIG. 27 is a cross-sectional view of a pixel unit included in a reflective-type display device according to example embodiments; and

FIGS. 28 and 29 are cross-sectional views illustrating a method of driving the reflective-type display device illustrated in FIG. 27 according to example embodiments.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, the present invention is not limited to example embodiments described.

Example embodiments relate to display devices. Other example embodiments relate to reflective-type color display devices using polymer dispersed liquid crystals (PDLC) and dyes.

A reflective-type display device according to example embodiments includes a plurality of pixel units that represent unit colors of an image.

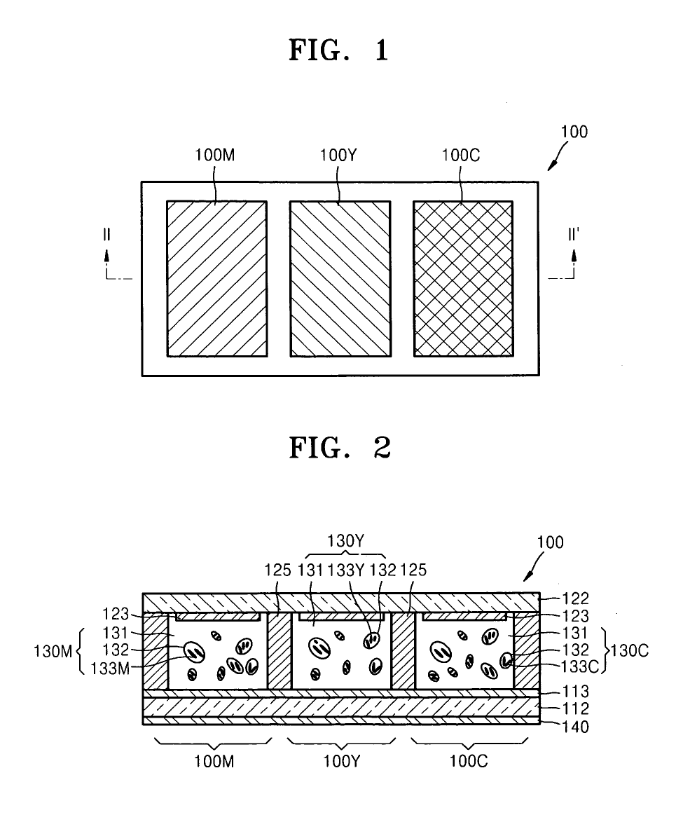

FIG. 1 is a plan view of a pixel unit 100 included in a reflective-type display device according to example embodiments. FIG. 2 is a cross-sectional view taken along a line II-II′ of FIG. 1.

Referring to FIG. 1, the pixel unit 100 may include a plurality of different color sub pixels. For example, the pixel unit 100 may include a magenta sub pixel 100M, a yellow sub pixel 100Y and a cyan sub pixel 100C.

Referring to FIG. 2, the pixel unit 100 includes first and second substrates 112 and 122 disposed apart from each other, a plurality of first electrodes 113 and a plurality of second electrodes 123 respectively disposed on the first and second substrates 112 and 122, a plurality of different color polymer dispersed liquid crystal (PDLC) layers 130M, 130Y, and 130C that are disposed between the first electrodes 113 and the second electrodes 123, and a reflective layer 140 disposed on the first substrate 112.

The first substrate 112 and the second substrate 122, which are respectively a lower substrate and an upper substrate, may be transparent substrates. The first substrate 112 and the second substrate 122 may be formed of, but are not limited to, glass or plastic. The first electrodes 113 are disposed on a top surface of the first substrate 112 and the second electrodes 123 are disposed on a bottom surface of the second substrate 122. The first and second electrodes 113 and 123 may be formed of a transparent conductive material (e.g., an indium tin oxide (ITO)). In a passive matrix (PM) display device, the first electrodes 113 may be formed in stripes parallel to each other, and the second electrodes 123 may be formed in stripes parallel to each other while intersecting the first electrodes 113. In an active matrix (AM) display device, the first electrodes 113 may be formed in a single body to act as a common electrode and the second electrodes 123 may be respectively formed to correspond to the sub pixels 100M, 100Y and 100C, or vice versa.

The different color PDLC layers 130M, 130Y and 130C are disposed between the first electrodes 113 and the second electrodes 123. The different color PDLC layers 130M, 130Y and 130C respectively include different color dyes 133M, 133Y, and 133C. For example, the magenta sub pixel 100M may include the magenta PDLC layer 130M having the magenta dyes 133M. The magenta PDLC layer 130M may include a polymer 131, liquid crystals 132 dispersed in the polymer 131, and the magenta dyes 133M included in the liquid crystals 132. The yellow sub pixel 100Y includes the yellow PDLC layer 130Y having the yellow dyes 133Y. The yellow PDLC layer 130Y may include a polymer 131, liquid crystals 132 dispersed in the polymer 131, and the yellow dyes 133Y contained in the liquid crystals 132. The cyan sub pixel 100C includes the cyan PDLC layer 130C having the cyan dyes 133C. The cyan PDLC layer 130C may include a polymer 131, liquid crystals 132 dispersed in the polymer 131, and the cyan dyes 133C contained in the liquid crystals 132. Although the different color dyes 133M, 133Y and 133C are described as being included in the liquid crystals 132, they may be included in the polymers 131 or both the polymers 131 and liquid crystals 132.

Barrier ribs 125 may be disposed between the first substrate 112 and the second substrate 122 in order to separate the different color PDLC layers 130M, 130Y and 130C from one another, thereby preventing colors from being mixed. The reflective layer 140 may be disposed on the bottom surface of the first substrate 112 to reflect light incident thereon.

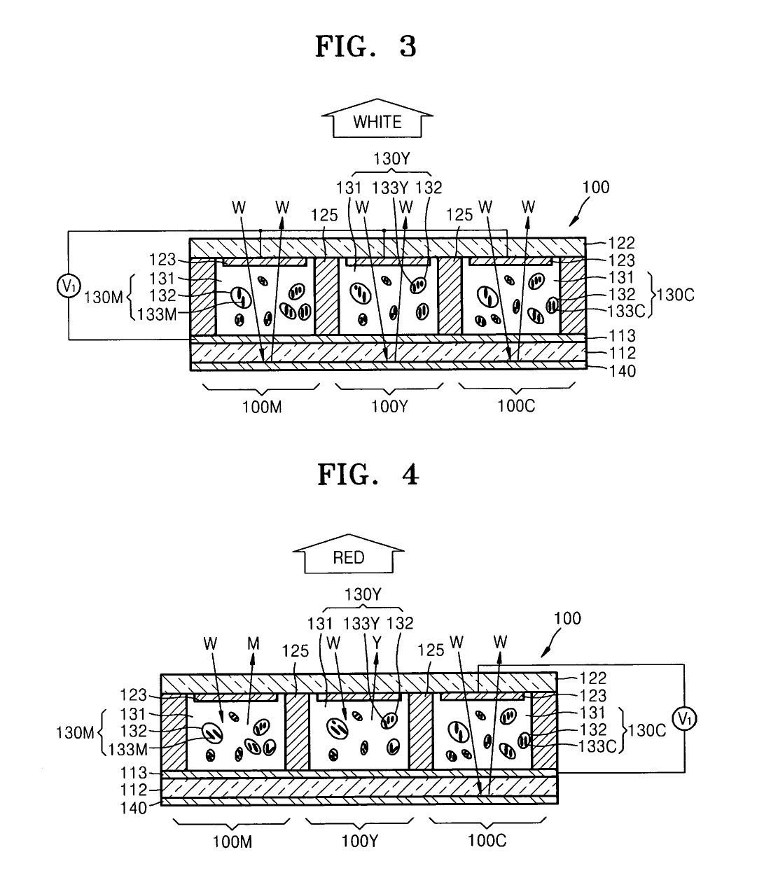

FIGS. 3 to 5 are cross-sectional views illustrating a method of driving the reflective-type display device illustrated in FIGS. 1 and 2 according to example embodiments.

Referring to FIG. 3, a voltage V₁ is applied between the first electrodes 113 and the second electrodes 123 that respectively correspond to any one of the magenta sub pixel 100M, the yellow sub pixel 100Y and the cyan sub pixel 100C. The magenta dyes 133M, the yellow dyes 133Y and the cyan dyes 133C, which are respectively included in the magenta PDLC layer 130M, the yellow PDLC layer 130Y and the cyan PDLC layer 130C, are arranged to be parallel to an electric field formed between the first electrodes 113 and the second electrodes 123. External white light W penetrates the magenta PDLC layer 130M, the yellow PDLC layer 130Y and the cyan PDLC layer 130C, and arrives at the reflective layer 140. The white light W is reflected by the reflective layer 140 and is subsequently emitted to the outside via the second substrate 122. As such, the pixel unit 100 assumes white.

Referring to FIG. 4, for example, the voltage V₁ is applied between the first electrode 113 and the second electrode 123 that correspond to the cyan sub pixel 100C. The cyan dyes 133C contained in the cyan PDLC layer 130C are arranged to be parallel to an electric field formed between the first electrode 113 and the second electrode 123. External white light W incident on the cyan PDLC layer 130C penetrates the cyan PDLC layer 130C, which arrives at the reflective layer 140, is reflected by the reflective layer 140. The reflected white light W is emitted to the outside via the second substrate 122. The external white light W, which is incident on the magenta PDLC layer 130M to which no voltage, is applied is scattered due to the optical characteristics of the polymer 131 and the liquid crystals 132. The scattered light acts on the magenta dyes 133M, and the magenta light M is emitted to the outside via the second substrate 122. The external white light W, which is incident on the yellow PDLC layer 130Y, is scattered due to the optical characteristics of the polymer 131 and the liquid crystals 132. The scattered light acts on the yellow dyes 133Y, and thus yellow light Y is emitted to the outside via the second substrate 122. As such, the magenta light M, the yellow light Y and the white light W are respectively emitted from the magenta sub pixel 100M, the yellow sub pixel 100Y and the cyan sub pixel 100C. Thus, the pixel unit 100 assumes red.

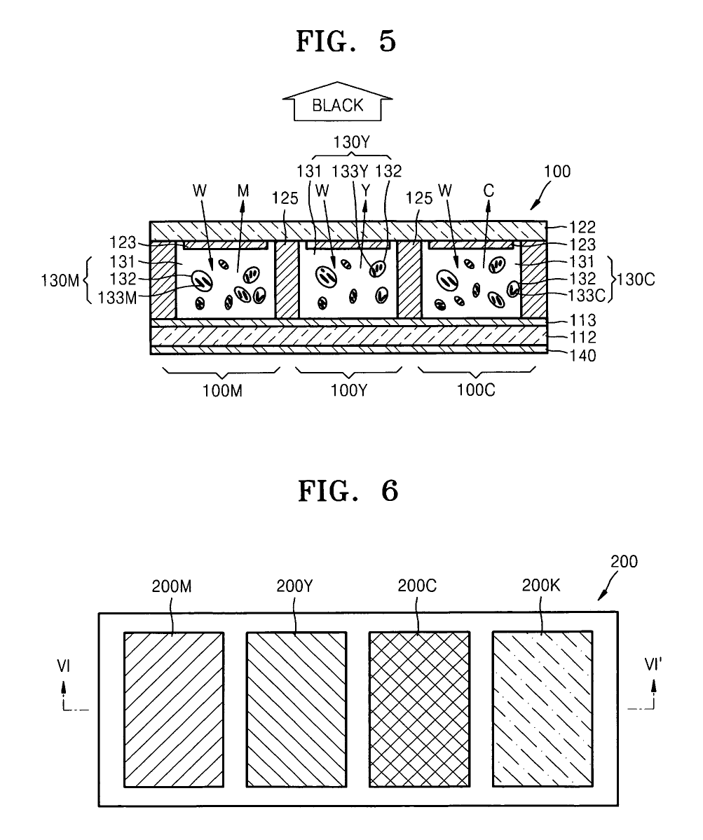

Referring to FIG. 5, no voltage is applied between the first electrodes 112 and the second electrodes 122 that correspond to the magenta sub pixel 100M, the yellow sub pixel 100Y and the cyan sub pixel 100C. External white light W, which is incident on the magenta PDLC layer 130M, is scattered due to the optical characteristics of the polymer 131 and the liquid crystals 132. The scattered light acts on the magenta dyes 133M, and thus magenta light M is emitted to the outside via the second substrate 122. The external white light W, which is incident on the yellow PDLC layer 130Y, is scattered due to the optical characteristics of the polymer 131 and the liquid crystals 132. The scattered light acts on the yellow dyes 133Y, and thus yellow light Y is emitted to the outside via the second substrate 122. The external white light W, which is incident on the cyan PDLC layer 130C, is scattered according to the optical characteristics of the polymer 131 and the liquid crystals 132. The scattered light acts on the cyan dyes 133C, and thus cyan light C is emitted to the outside via the second substrate 122. The magenta light M, the yellow light Y and the cyan light C are respectively emitted from the magenta sub pixel 100M, the yellow sub pixel 100Y and the cyan sub pixel 100C. As such, the pixel unit 100 assumes black, which is darker than the white assumed by the pixel unit 100 illustrated in FIG. 3.

In the above embodiments, the pixel unit 100 includes the magenta sub pixel 100M, the yellow sub pixel 100Y and the cyan sub pixel 100C but is not limited thereto and may include various sub pixels. For example, the pixel unit 100 may include a red sub pixel, a green sub pixel and a blue sub pixel.

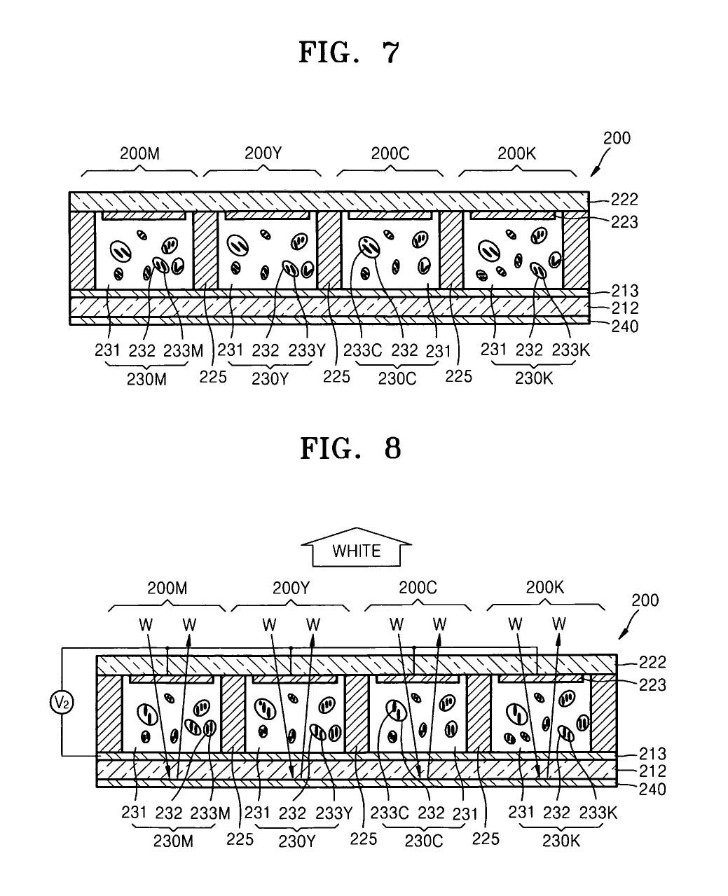

FIG. 6 is a plan view of a pixel unit 200 included in a reflective-type display device according to example embodiments. FIG. 7 is a cross-sectional view taken along a line VI-VI′ of FIG. 6. The pixel unit 200 will now be described focusing on the differences between the pixel unit 200 and the pixel 100 illustrated in FIGS. 1 and 2.

Referring to FIG. 6, the pixel unit 200 may include a plurality of different color sub pixels 200M, 200Y and 200C and a black and white sub pixel 200K. For example, the pixel unit 200 may include a magenta sub pixel 200M, a yellow sub pixel 200Y, a cyan sub pixel 200C and the black and white sub pixel 200K.

Referring to FIG. 7, the pixel unit 200 includes first and second substrates 212 and 222 that are disposed apart from each other, a plurality of first electrodes 213 and a plurality of second electrodes 223 that are respectively disposed on the first and second substrates 212 and 222, a magenta PDLC layer 230M, a yellow PDLC layer 230Y, a cyan PDLC layer 230C and a black PDLC layer 230K that are disposed between the first electrodes 213 and the second electrodes 223. A reflective layer 240 may be disposed on the first substrate 212.

The first and second substrate 212 and 222 may be transparent substrates (e.g., a glass substrate or a plastic substrate). The first electrodes 213 are disposed on a top surface of the first substrate 212 and the second electrodes 233 are disposed on a bottom surface of the second substrate 222. The first and second electrodes 213 and 223 may be formed of a transparent conductive material.

The magenta PDLC layer 230M, the yellow PDLC layer 230Y, the cyan PDLC layer 230C and the black PDLC layer 230K are disposed between the first electrodes 213 and the second electrodes 223. The PDLC layers 230M, 230Y, 230C and 230K respectively include different color dyes 233M, 233Y, 233C and 233K. In detail, the magenta PDLC layer 230M corresponding to the magenta sub pixel 200M may include a polymer 231, liquid crystals 232 dispersed in the polymer 231 and the magenta dyes 233M contained in the liquid crystals 232. The yellow PDLC layer 230Y corresponding to the yellow sub pixel 200Y may include a polymer 231, liquid crystals 232 dispersed in the polymer 231 and the yellow dyes 233Y contained in the liquid crystals 232. The cyan PDLC layer 230C corresponding to the cyan sub pixel 200C may include a polymer 231, liquid crystals dispersed in the polymer 231 and the cyan dyes 233C contained in the liquid crystals 232. The black PDLC layer 230K corresponding to the black and white sub pixel 200K may include a polymer 231, liquid crystals 232 dispersed in the polymer 231 and the black dyes 233K contained in the liquid crystals 232. Although the different color dyes 233M, 233Y, 233C and 233K are described as being contained in the liquid crystals 232, the different color dyes 233M, 233Y, 233C and 233K are not limited thereto and may be contained in either the polymers 231 or both the polymers 231 and the liquid crystals 232.

Barrier ribs 225 may be disposed between the first substrate 212 and the second substrate 222 to separate the different color PDLC layers 230M, 230Y, 230C and 230K from one another, thereby preventing colors from being mixed. The reflective layer 240 is disposed at the bottom surface of the first substrate 212 to reflect light incident thereon.

FIGS. 8 to 11 are cross-sectional views illustrating a method of driving the reflective-type display device illustrated in FIGS. 6 and 7 according to example embodiments.

Referring to FIG. 8, a voltage V₂ is applied between the first electrodes 213 and the second electrodes 223 that correspond to the magenta sub pixel 200M, the yellow sub pixel 200Y, the cyan sub pixel 200C and the black and white sub pixel 200K. The magenta dyes 233M, the yellow dyes 233Y, the cyan dyes 233C and the black dyes 233K, which are respectively contained in the magenta PDLC layer 230M, the yellow PDLC layer 230Y, the cyan PDLC layer 230C and the black PDLC layer 230K, are arranged to be parallel with an electric field formed between the first electrodes 213 and the second electrodes 223. External white light W penetrates the magenta PDLC layer 230M, the yellow PDLC layer 230Y, the cyan PDLC layer 230C and the black PDLC layer 230K, arrives at the reflective layer 240, is reflected by the reflective layer 240, and is subsequently emitted to the outside via the second substrate 222. Thus, the pixel unit 200 assumes white.

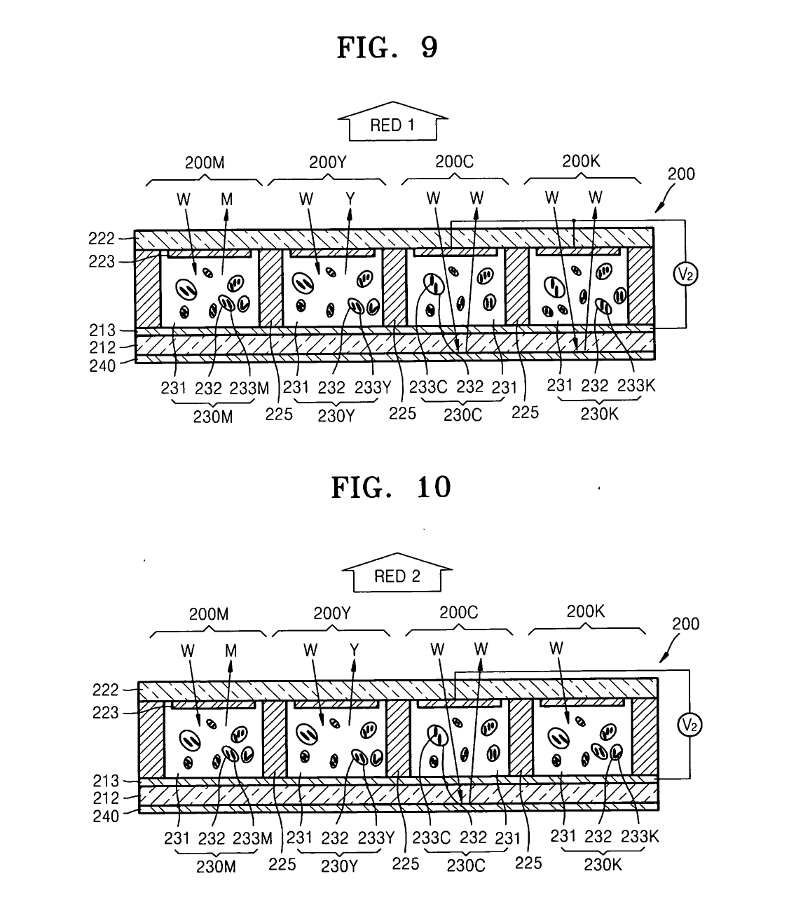

Referring to FIG. 9, for example, the voltage V₂ is applied between the first electrodes 213 and the second electrodes 223 that correspond to the cyan sub pixel 200C and the black and white sub pixel 200K. The cyan dyes 233C contained in the cyan PDLC layer 230C and the black dyes 233K contained in the PDLC layer 230K are arranged to be parallel to an electric field formed between the first electrodes 213 and the second electrodes 223. External white light W incident on the cyan PDLC layer 230C and the black PDLC layer 230K penetrates the cyan PDLC layer 230C and the black PDLC layer 230K, arrives at the reflective layer 240, is reflected by the reflective layer 240, and is subsequently emitted to the outside via the second substrate 222. The external white light W, which is incident on the magenta PDLC layer 230M to which no voltage is applied, is scattered due to the optical characteristics of the polymer 231 and the liquid crystals 232. The scattered light acts on the magenta dyes 233M, and thus magenta light M is emitted to the outside via the second substrate 222. The external white light W, which is incident on the yellow PDLC layer 230Y, is scattered due to the optical characteristics of the polymer 231 and the liquid crystals 232. The scattered light acts on the yellow dyes 233Y, and thus yellow light Y is emitted to the outside via the second substrate 222. The magenta light M, the yellow light Y, the white light W and the white light W are respectively emitted from the magenta sub pixel 200M, the yellow sub pixel 200Y, the cyan sub pixel 200C and the black and white sub pixel 200K. Thus, the pixel unit 200 assumes red 1.

Referring to FIG. 10, for example, the voltage V₂ is applied between the first electrode 213 and the second electrode 223 that correspond to the cyan sub pixel 200C. The cyan dyes 233C contained in the cyan PDLC layer 230C are arranged to be parallel to an electric field formed between the first electrode 213 and the second electrode 223. External white light W, which is incident on the cyan PDLC layer 230C, penetrates the cyan PDLC layer 230C. The penetrated white light W arrives at the reflective layer 240, is reflected by the reflective layer 240, and is subsequently emitted to the outside via the second substrate 222. The external white light W, which is incident on the magenta PDLC layer 230M to which no voltage is applied, is scattered due to the optical characteristics of the polymer 231 and the liquid crystals 232. The scattered light acts on the magenta dyes 233M, and thus magenta light M is emitted to the outside via the second substrate 222. The external white light W, which incident on the yellow PDLC layer 230Y, is scattered due to the optical characteristics of the polymer 231 and the liquid crystals 232. The scattered light acts on the yellow dyes 233Y, and thus yellow light Y is emitted to the outside via the second substrate 222. The external white light W, which is incident on the black PDLC layer 230K, is absorbed by the black dyes 233K. The magenta light M, the yellow light Y and the white light W are respectively emitted from the magenta sub pixel 200M, the yellow sub pixel 200Y and the cyan sub pixel 200C. The black and white sub pixel 200K assumes black, from which no light is emitted. The pixel unit 200 assumes red 2, which is darker than the red 1 assumed by the pixel unit 200 in FIG. 9.

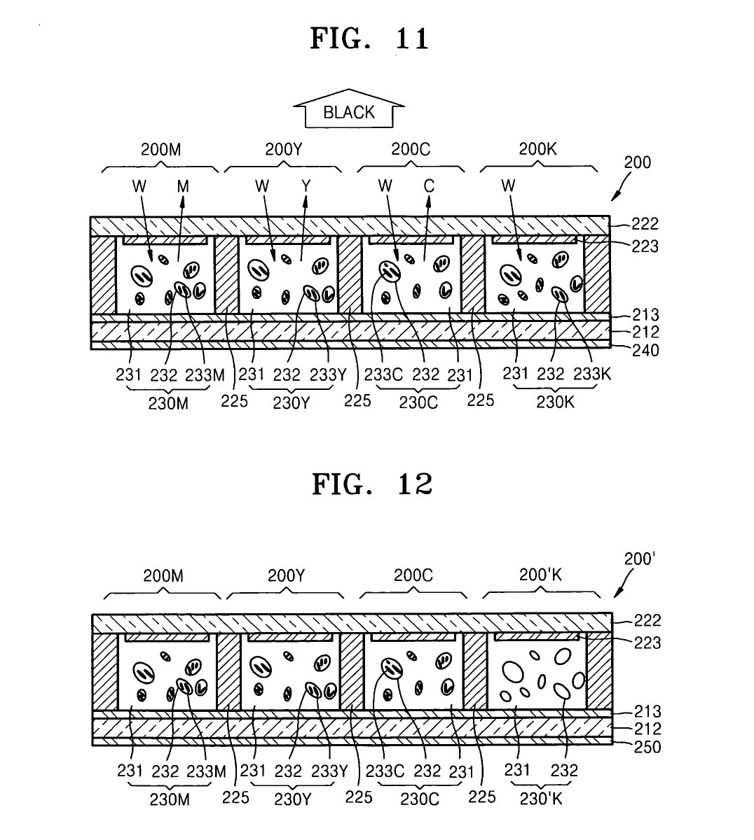

Referring to FIG. 11, no voltage is applied between the first electrodes 213 and the second electrodes 223 that correspond to the magenta sub pixel 200M, the yellow sub pixel 200Y, the cyan sub pixel 200C, and the black and white sub pixel 200K. External white light W, which is incident on the magenta PDLC layer 230M, is scattered due to the optical characteristics of the polymer 231 and the liquid crystals 232. The scattered light acts on the magenta dyes 233M, and thus magenta light M is emitted to the outside via the second substrate 222. The external white light W incident on the yellow PDLC layer 230Y is scattered due to the optical characteristics of the polymer 231 and the liquid crystals 232. The scattered light acts on the yellow dyes 233Y, and thus yellow light Y is emitted to the outside via the second substrate 222. The external white light W, which is incident on the cyan PDLC layer 230C, is scattered due to the optical characteristics of the polymer 231 and the liquid crystals 232. The scattered light acts on the cyan dyes 233C, and thus cyan light C is emitted to the outside via the second substrate 222. The external white light W, which is incident on the black PDLC layer 230K, is absorbed by the black dyes 233K. The magenta light M, the yellow light Y and the cyan light C are respectively emitted from the magenta sub pixel 200M, the yellow sub pixel 200Y and the cyan sub pixel 200C. The black and white sub pixel 200K assumes black, from which no light is emitted. Thus, the pixel unit 200 assumes black, which is darker than the white assumed by the pixel unit 200 in FIG. 8.

As described above, in example embodiments, the black and white pixel sub pixel 200K that displays black or white is used, thereby increasing contrast and color reproduction and enhancing gray-scale characteristics. In the above embodiments, the pixel unit 200 is described as including the magenta sub pixel 200M, the yellow sub pixel 200Y, the cyan sub pixel 200C, and the black and white sub pixel 200K but is not limited thereto and may include various sub pixels. For example, the pixel unit 200 may include a red sub pixel, a green sub pixel, a blue sub pixel and a black and white sub pixel.

FIG. 12 is a cross-sectional view of a pixel unit 200′ included in a reflective-type display device according to example embodiments. The pixel unit 200′ will now be described focusing on the differences between the pixel unit 200′ and the above pixel units 100 and 200 according to the above example embodiments.

Referring to FIG. 12, the pixel unit 200′ may include a magenta sub pixel 200M, a yellow sub pixel 200Y, a cyan sub pixel 200C and a black and white sub pixel 200′K. The pixel unit 200′ includes first and second substrates 212 and 222 that are disposed apart from each other, a plurality of first electrodes 213 and a plurality of second electrodes 223 that are respectively disposed on the first and second substrates 212 and 222, a magenta PDLC layer 230M, a yellow PDLC layer 230Y, a cyan PDLC layer 230C and a PDLC layer 230′K that are disposed between the first electrodes 212 and the second electrodes 213, and an absorption layer 250 disposed on the first substrate 212.

The magenta PDLC layer 230M corresponding to the magenta sub pixel 200M may include a polymer 231, liquid crystals 232 dispersed in the polymer 231, and magenta dyes 233M contained in the liquid crystals 232. The yellow PDLC layer 230Y corresponding to the yellow sub pixel 200Y may include a polymer 231, liquid crystals 232 dispersed in the polymer 231, and yellow dyes 233Y contained in the liquid crystals 232. The cyan PDLC layer 230C corresponding to the cyan sub pixel 200C may include a polymer 231, liquid crystals 232 dispersed in the polymer 231, and cyan dyes 233C contained in the liquid crystals 232. The PDLC layer 230′K corresponding to the black and white sub pixel 200′K does not contain dyes and may include a polymer 231 and liquid crystals 232 dispersed in the polymer 231. Although the dyes 233M, 233Y and 233C are described as being contained in the liquid crystals 232, they are not limited to the above description and may be included in either the polymer 231 or the polymer 231 and the liquid crystals 232.

Barrier ribs 225 may be disposed between the first substrate 212 and the second substrate 222 in order to separate the different color PDLC layers 230M, 230Y, 230C and 230′K, thereby preventing colors from being mixed. The absorption layer 250 may be disposed on the bottom surface of the first substrate 212 in order to reflect light incident thereon.

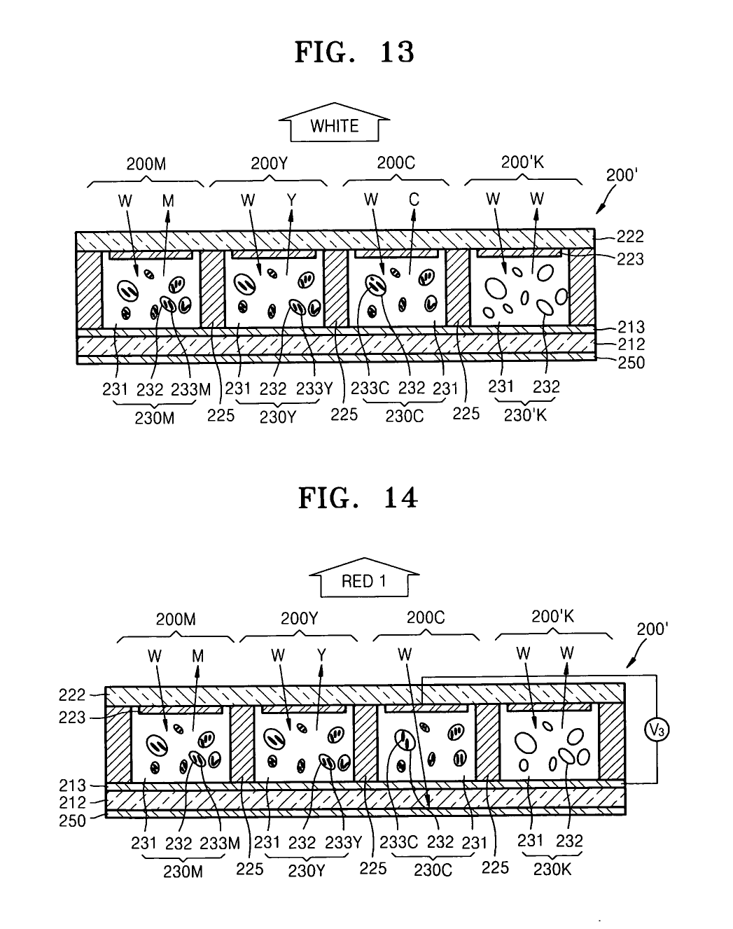

FIGS. 13 through 16 are cross-sectional views illustrating a method of driving the reflective-type display device illustrated in FIG. 12 according to example embodiments.

Referring to FIG. 13, no voltage is applied between the first electrodes 213 and the second electrodes 223 that correspond to the magenta sub pixel 200M, the yellow sub pixel 200Y, the cyan sub pixel 200C and the black and white sub pixel 200′K. External white light W, which is incident on the magenta PDLC layer 230M, is scattered due to the optical characteristics of the polymer 231 and the liquid crystals 232. The scattered light acts on the magenta dyes 233M, and thus magenta light M is emitted to the outside via the second substrate 222. The external white light W incident on the yellow PDLC layer 230Y is scattered due to the optical characteristics of the polymer 231 and the liquid crystals 232. The scattered light acts on the yellow dyes 233Y, and thus yellow light Y is emitted to the outside via the second substrate 222. The external white light W, which is incident on the cyan PDLC layer 230C, is scattered due to the optical characteristics of the polymer 231 and the liquid crystals 232. The scattered light acts on the cyan dyes 233C, and thus cyan light C is emitted to the outside via the second substrate 222. The external white light W, which is incident on the PDLC layer 230′K, is scattered due to the optical characteristics of the polymer 231 and the liquid crystals 232. The scattered external white light W is emitted to the outside via the second substrate 222. The magenta light M, the yellow light Y, the cyan light C and the white light W are respectively emitted from the magenta sub pixel 200M, the yellow sub pixel 200Y, the cyan sub pixel 200C and the black and white sub pixel 200′K. Thus, the pixel unit 200 assumes white.

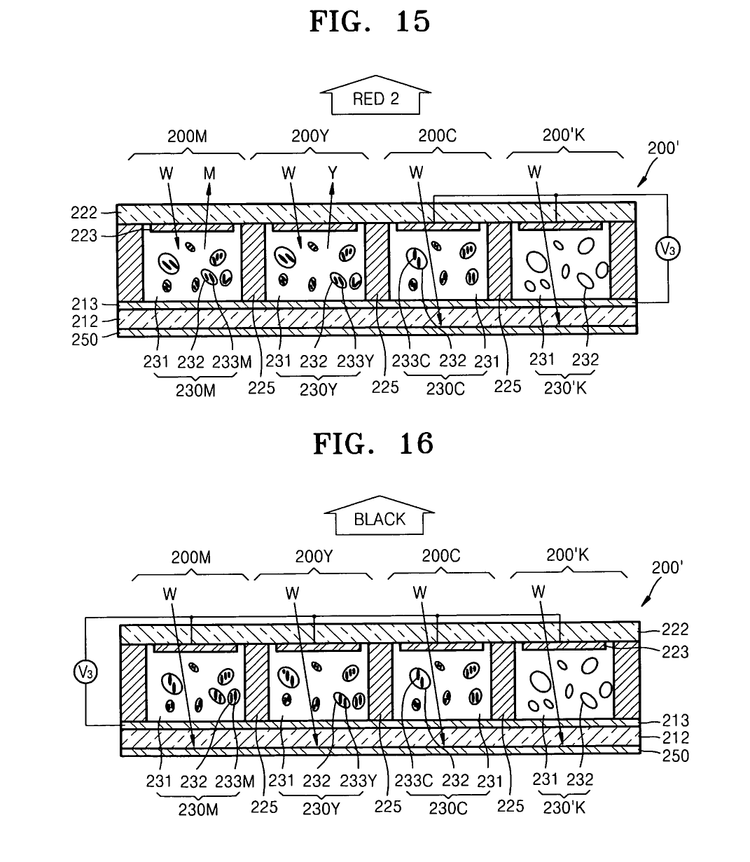

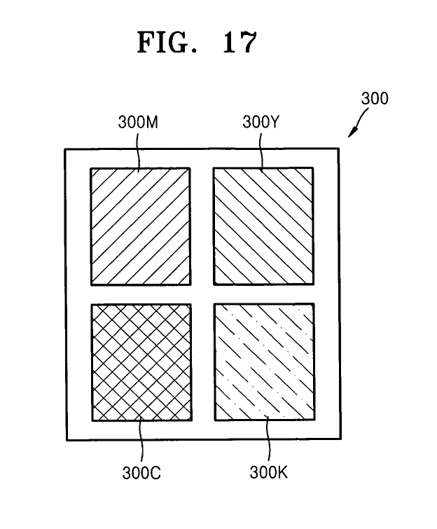

Referring to FIG. 14, for example, a voltage V₃ is applied between the first electrode 213 and the second electrode 223 that correspond to the cyan sub pixel 200C. The cyan dyes 233C contained in the cyan PDLC layer 230C are arranged to be parallel to an electric field formed between the first electrode 213 and the second electrode 223. The external white light W incident on the cyan PDLC layer 230C penetrates the cyan PDLC layer 230C, and the penetrated external white light W is subsequently absorbed by the absorption layer 250. The external white light W, which is incident on the magenta PDLC layer 230M to which no voltage is applied, is scattered due to the optical characteristics of the polymer 231 and the liquid crystals 232. The scattered light acts on the magenta dyes 233M, and thus magenta light M is emitted to the outside via the second substrate 222. The external white light W, which is incident on the yellow PDLC layer 230Y, is scattered due to the optical characteristics of the polymer 231 and the liquid crystals 232. The scattered light acts on the yellow dyes 233Y, and thus yellow light Y is emitted to the outside via the second substrate 222. The external white light W, which is incident on the PDLC layer 230′K, is scattered due to the optical characteristics of the polymer 231 and the liquid crystals 232 and is then emitted to the outside via the second substrate 222. Accordingly, the magenta light M, the yellow light Y and the white light W are respectively emitted from the magenta sub pixel 200M, the yellow sub pixel 200Y and the black and white sub pixel 200′K, and the cyan sub pixel 200C assumes black, from which no light is emitted. Thus, the pixel unit 200′ assumes red 1.

Referring to FIG. 15, for example, the voltage V₃ is applied between the first electrodes 213 and the second electrodes 223 that correspond to the cyan sub pixel 200C and the black and white sub pixel 200′K. The cyan dyes 233C contained in the cyan PDLC layer 230C are arranged to be parallel to an electric field formed between the first electrode 213 and the second electrode 223. External white light W incident on the cyan PDLC layer 230C penetrates the cyan PDLC layer 230C and is subsequently absorbed by the absorption layer 250. In the PDLC layer 230′K, because liquid crystal molecules contained in the liquid crystals 232 are arranged in parallel with the electric field, the external white light W incident on the PDLC layer 230′K penetrates the PDLC layer 230′K and is subsequently absorbed by the absorption layer 250. The external white light W, which is incident on the magenta PDLC layer 230M to which no voltage is applied, is scattered due to the optical characteristics of the polymer 231 and the liquid crystals 232. The scattered light acts on the magenta dyes 233M, and thus magenta light M is emitted to the outside via the second substrate 222. The external white light W incident on the yellow PDLC layer 230Y is scattered due to the optical characteristics of the polymer 231 and the liquid crystals 232. The scattered light acts on the yellow dyes 233Y, and thus yellow light Y is emitted to the outside via the second substrate 222. The magenta light M and the yellow light Y are respectively emitted from the magenta sub pixel 200M and the yellow sub pixel 200Y, and the cyan sub pixel 200C and the black and white sub pixel 200′K assume black, from which no light is emitted. As such, the pixel unit 200′ assumes red 2, which is darker than the red 1 assumed by the pixel unit 200′ in FIG. 14.

Referring to FIG. 16, the voltage V₃ is applied between the first electrodes 213 and the second electrodes 223 that correspond to the magenta sub pixel 200M, the yellow sub pixel 200Y, the cyan sub pixel 200C and the black and white sub pixel 200′K. The magenta dyes 233M, the yellow dyes 233Y, the cyan dyes 233C, and liquid crystal molecules, which are respectively contained in the magenta PDLC layer 230M, the yellow PDLC layer 230Y, the cyan PDLC layer 230C, and the PDLC layer 230′K, are arranged to be parallel to an electric field formed between the first electrodes 213 and the second electrodes 223. External white light W penetrates the magenta PDLC layer 230M, the yellow PDLC layer 230Y, the cyan PDLC layer 230C and the PDLC layer 230′K and is subsequently absorbed by the absorption layer 250. Thus, the pixel unit 200′ assumes black.

Although in the above embodiments, the pixel unit 200′ is described as including the magenta sub pixel 200M, the yellow sub pixel 200Y, the cyan sub pixel 200C, and the black and white sub pixel 200′K, the pixel unit 200′ is not limited to the above description and may include various sub pixels. For example, the pixel unit 200′ may include a red sub pixel, a green sub pixel, a blue sub pixel and a black and white sub pixel.

FIG. 17 is a plan view of a pixel unit 300 included in a reflective-type display device according to example embodiments. In the above embodiments, the four sub pixels 200M, 200Y, 200C and 200K of the pixel unit 200 are arranged in a line, but in FIG. 17, four sub pixels 300M, 300Y, 300C and 300K of the pixel unit 300 are arranged in two lines. Here, the pixel unit 300 includes the magenta sub pixel 300M, the yellow sub pixel 300Y, the cyan sub pixel 300C and the black and white sub pixel 300K. However, example embodiments are not limited thereto. Thus, the pixel unit 300 may include a red sub pixel, a green sub pixel, a blue sub pixel and a black and white sub pixel.

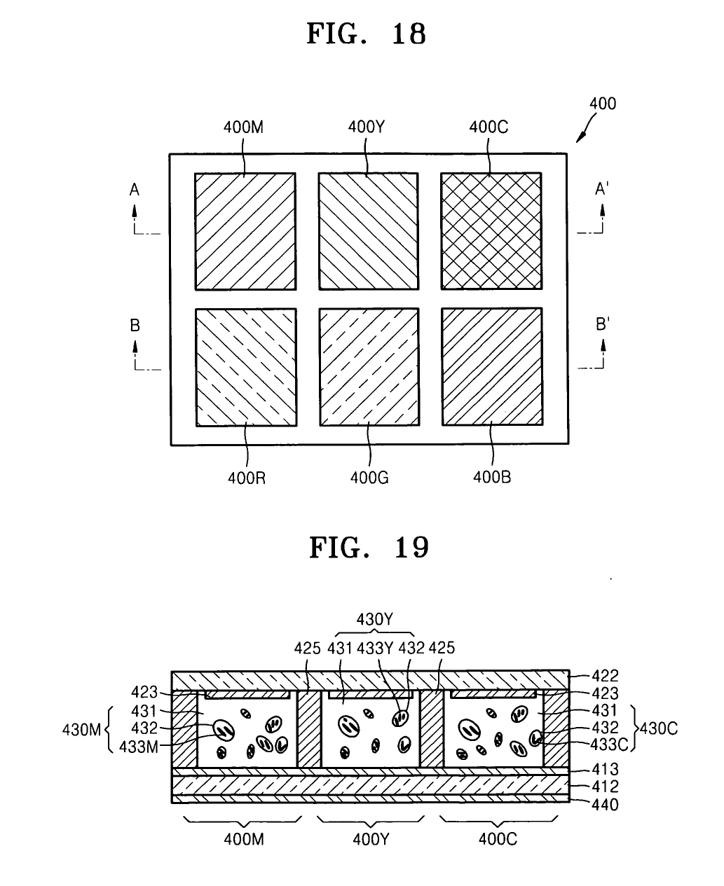

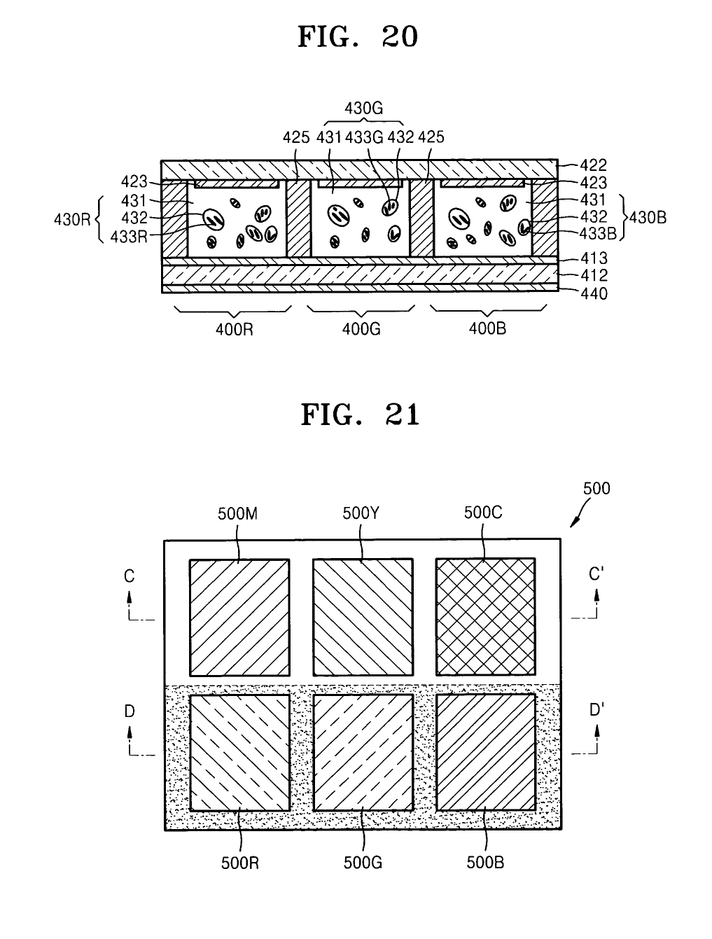

FIG. 18 is a plan view of a pixel unit 400 included in a reflective-type display device according to example embodiments. FIG. 19 is a cross-sectional view taken along a line A-A′ of FIG. 18. FIG. 20 is a cross-sectional view taken along a line B-B′ of FIG. 18. The pixel unit 400 will now be described focusing on the differences between the pixel unit 400 and the pixel units 100, 200, 200′ and 300 according to the above embodiments.

Referring to FIG. 18, the pixel unit 400 may include six different color sub pixels. For example, the pixel unit 400 may include a magenta sub pixel 400M, a yellow sub pixel 400Y, a cyan sub pixel 400C, a red sub pixel 400R, a green sub pixel 400G and a blue sub pixel 400B. The six sub pixels 400M, 400Y, 400C, 400R, 400G and 400B may be arranged in two lines as illustrated in FIG. 18 but are not limited thereto and may be arranged in various ways.

Referring to FIGS. 19 and 20, the pixel unit 400 includes first and second substrates 412 and 422 that are disposed apart from each other, a plurality of first electrodes 413 and a plurality of second electrodes 423 that are respectively disposed on the first and second substrates 412 and 422, different color PDLC layers 430M, 430Y, 430C, 430R, 430G and 430B that are disposed between the first electrodes 413 and the second electrodes 423 and a reflective layer 440 disposed on the first substrate 412.

The different color PDLC layers 430M, 430Y, 430C, 430R, 430G and 430B respectively include different color dyes 433M, 433Y, 433C, 433R, 433G and 433B. For example, the magenta PDLC layer 430M corresponding to the magenta sub pixel 400M may include a polymer 431, liquid crystals 432 dispersed in the polymer 431, and the magenta dyes 433M contained in the liquid crystals 432. The yellow PDLC layer 430Y corresponding to the yellow sub pixel 400Y may include a polymer 431, liquid crystals 432 dispersed in the polymer 431, and the yellow dyes 433Y contained in the liquid crystals 432. The cyan PDLC layer 430C corresponding to the cyan sub pixel 400C may include a polymer 431, liquid crystals 432 dispersed in the polymer 431, and the cyan dyes 433C contained in the liquid crystals 432. The red PDLC layer 430R corresponding to the red sub pixel 400R may include a polymer 431, liquid crystals 432 dispersed in the polymer 431, and the red dyes 433R contained in the liquid crystals 432. The green PDLC layer 430G corresponding to the green sub pixel 400G may include a polymer 431, liquid crystals 432 dispersed in the polymer 431, and the green dyes 433G contained in the liquid crystals 432. The blue PDLC layer 430B corresponding to the blue sub pixel 400B may include a polymer 431, liquid crystals 432 dispersed in the polymer 431, and the blue dyes 433B contained in the liquid crystals 432. Although the different color dyes 433M, 433Y, 433C, 433R, 433G and 433B are described as being included in the liquid crystals 432, they are not limited to the above description and may be included in either the polymer 431 or in the polymer 431 and the liquid crystals 432.

Barrier ribs 425 may be disposed between the first substrate 412 and the second substrate 422 in order to separate the different color PDLC layers 430M, 430Y, 430C, 430R, 430G and 430B from one another, thereby preventing the colors from mixing. The reflective layer 440 is disposed on (or across) an entire bottom surface of the first substrate 412 in order to reflect light incident thereon. Alternatively, an absorption layer (not shown) may be disposed on (or across) the entire bottom surface of the first substrate 412 in order to absorb light incident thereon. The principle that different color lights are emitted from different color sub pixels has been described above with respect to the reflective-type color display devices according to example embodiments, therefore a description thereof will not be repeated for the sake of brevity. According to example embodiments, if the pixel unit 400 includes the six different color sub pixels 400M, 400Y, 400C, 400R, 400G and 400B, then color reproduction and gray-scale characteristics may be enhanced.

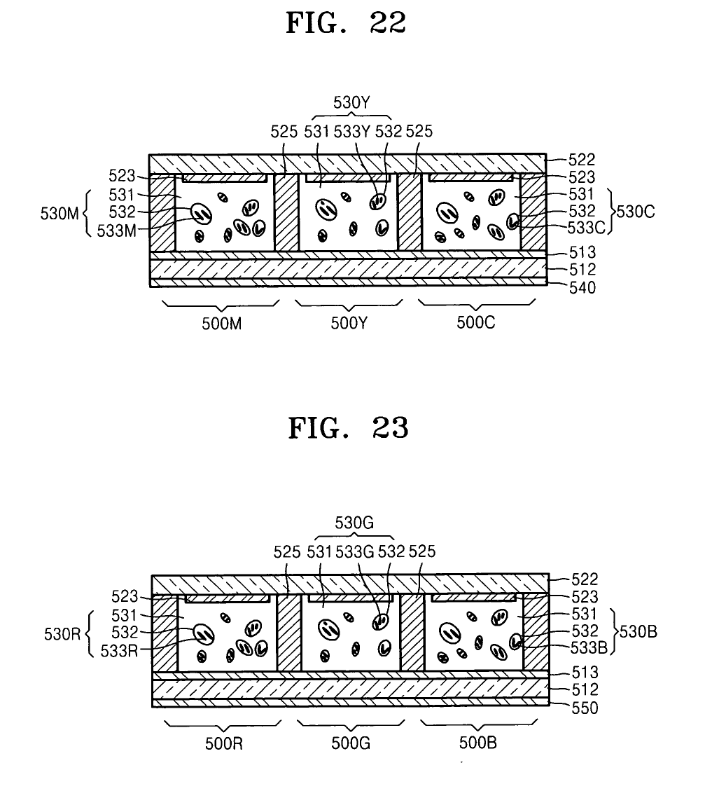

FIG. 21 is a plan view of a pixel unit 500 included in a reflective-type display device according to example embodiments. FIG. 22 is a cross-sectional view taken along a line C-C′ of FIG. 21. FIG. 23 is a cross-sectional view taken along a line D-D′ of FIG. 21.

Referring to FIG. 21, the pixel unit 500 may include six different color sub pixels. For example, the pixel unit 500 may include a magenta sub pixel 500M, a yellow sub pixel 500Y, a cyan sub pixel 500C, a red sub pixel 500R, a green sub pixel 500G and a blue sub pixel 500B. The six sub pixels 500M, 500Y, 500C, 500R, 500G and 500B may be arranged in two lines as illustrated in FIG. 21. Alternatively, the sub pixels may be arranged in various ways.

Referring to FIGS. 22 and 23, the pixel unit 500 may include first and second substrates 512 and 522 that are disposed apart from each other, a plurality of first electrodes 513 and a plurality of second electrodes 523 that are respectively disposed on the first and second substrates 512 and 522, different color PDLC layers 530M, 530Y, 530C, 530R, 530G and 530B disposed between the first electrodes 513 and the second electrodes 523, and a reflective layer 540 and an absorption layer 550 that are disposed on the first substrate 512.

The different color PDLC layers 530M, 530Y, 530C, 530R, 530G and 530B respectively include different color dyes 533M, 533Y, 533C, 533R, 533G and 533B. For example, the magenta PDLC layer 530M corresponding to the magenta sub pixel 500M may include a polymer 531, liquid crystals 532 dispersed in the polymer 531, and the magenta dyes 533M contained in the liquid crystals 532. The yellow PDLC layer 530Y corresponding to the yellow sub pixel 500Y may include a polymer 531, liquid crystals 532 dispersed in the polymer 531, and the yellow dyes 533Y contained in the liquid crystals 532. The cyan PDLC layer 530C corresponding to the cyan sub pixel 500C may include a polymer 531, liquid crystals 532 dispersed in the polymer 531, and the cyan dyes 533C contained in the liquid crystals 532. The red PDLC layer 530R corresponding to the red sub pixel 500R may include a polymer 531, liquid crystals 532 dispersed in the polymer 531, and the red dyes 533R contained in the liquid crystals 532. The green PDLC layer 530G corresponding to the green sub pixel 500G may include a polymer 531, liquid crystals 532 dispersed in the polymer 531, and the green dyes 533G contained in the liquid crystals 532. The blue PDLC layer 530B corresponding to the blue sub pixel 500B may include a polymer 531, liquid crystals 532 dispersed in the polymer 531, and the blue dyes 533B contained in the liquid crystals 532. Although the different color dyes 533M, 533Y, 533C, 533R, 533G and 533B are described as being included in the liquid crystals 532, they are not limited to the above description and may be included in either the polymer 431 or in the polymer 431 and the liquid crystals 432. Barrier ribs 525 may be disposed between the first substrate 512 and the second substrate 522 in order to separate the different color PDLC layers 530M, 530Y, 530C, 530R, 530G and 530B from one another, thereby preventing the colors from mixing.

In example embodiments, the reflective layer 540 may be formed on a part of a bottom surface of the first substrate 512 that corresponds to the magenta sub pixel 500M, the yellow sub pixel 500Y and the cyan sub pixel 500C. The absorption layer 550 may be formed on another part of the bottom surface of the first substrate 512 that corresponds to the red sub pixel 500R, the green sub pixel 500G and the blue sub pixel 500B, or vice versa. The absorption layer 550 and the reflective layer 540 may be formed on various locations.

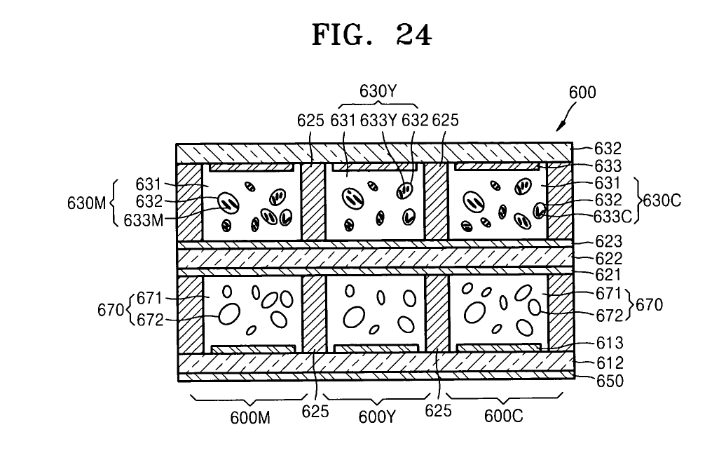

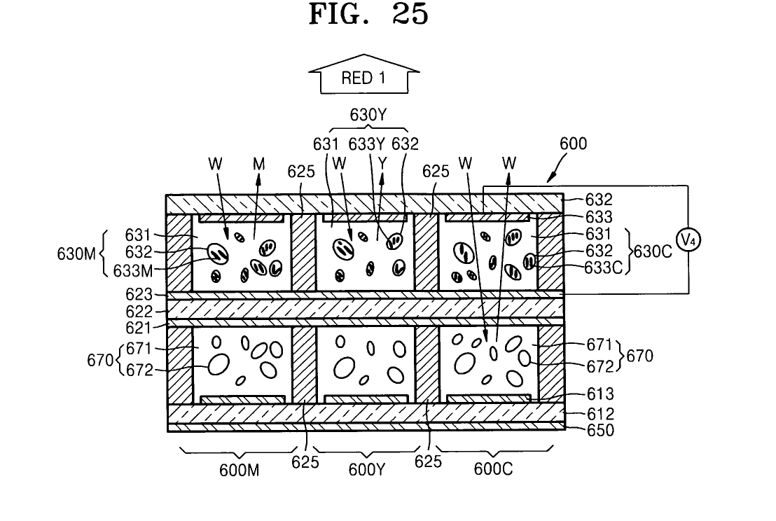

FIG. 24 is a cross-sectional view of a pixel unit 600 included in a reflective-type display device according to example embodiments. The pixel 600 illustrated in FIG. 24 will now be described focusing on the differences between the pixel unit 600 and the pixel units 100 to 500 according to example embodiments.

Referring to FIG. 24, the pixel unit 600 may include a magenta sub pixel 600M, a yellow sub pixel 600Y and a cyan sub pixel 600C. The pixel unit 600 may include first, second and third substrates 612, 622 and 632 that are disposed apart from each other, and a plurality of first electrodes 613 and a plurality of second electrode 621 that are respectively disposed on the first and second substrates 612 and 622. The pixel unit 600 may include a plurality of PDLC layers 670 disposed between the first electrodes 613 and the second electrodes 621, and a plurality of third electrodes 623 and a plurality of fourth electrodes 633 respectively disposed on the second and third substrates 622 and 632. A magenta PDLC layer 630M, a yellow PDLC layer 630Y and a cyan PDLC layer 630C may be disposed between the third electrodes 623 and the fourth electrodes 633. An absorption layer 650 may be disposed on the first substrate 612.

The first through third substrates 612 through 632 may be transparent substrates (e.g., a glass substrate or a plastic substrate). The plurality of the first electrodes 613 are disposed on a top surface of the first substrate 612, and the plurality of the second electrodes 621 are disposed on a bottom surface of the second substrate 622. The plurality of the third electrodes 623 are disposed on a top surface of the second substrate 622, and the plurality of the fourth electrodes 633 are disposed on a bottom surface of the third substrates 632. The first through fourth electrodes 613 through 633 may be formed of a transparent conductive material.

In a passive matrix (PM) display device, the first electrodes 613 and the second electrodes 621 may be disposed to intersect one another and the third electrodes 623 and the fourth electrodes 633 may be disposed to intersect one another. In an active matrix (AM) display device, the first electrodes 613 may be united to act as a common electrode and the second electrodes 621 may be formed to correspond to the sub pixels 600M, 600Y and 600C, or vice versa. The third electrodes 623 may be united (or joined) to act as a common electrode and the fourth electrodes 633 may be formed to correspond to the sub pixels 600M, 600Y and 600C, or vice versa.

The plurality of the PDLC layers 670 are disposed between the first electrodes 613 and the second electrodes 621 to correspond to the sub pixels 600M, 600Y and 600C. Each of the PDLC layers 670 includes a polymer 671 and liquid crystals 672 dispersed in the polymer 671. The PDLC layers 670 may be separated from each another via barrier ribs 625. The magenta PDLC layer 630M, the yellow PDLC layer 630Y and the cyan PDLC layer 630C are disposed between the third electrodes 623 and the fourth electrodes 633 to correspond to the sub pixels 600M, 600Y, and 600C. The magenta PDLC layer 630M, the yellow PDLC layer 630Y and the cyan PDLC layer 630C are disposed over the PDLC layers 670. The magenta PDLC layer 630M may include a polymer 631, liquid crystals 632 dispersed in the polymer 631, and magenta dyes 633M contained in the liquid crystals 632. The yellow PDLC layer 630Y may include a polymer 631, liquid crystals 632 dispersed in the polymer 631, and yellow dyes 633Y contained in the liquid crystals 632. The cyan PDLC layer 630C may include a polymer 631, liquid crystals 632 dispersed in the polymer 631, and cyan dyes 633C contained in the liquid crystals 632. The magenta PDLC layer 630M, the yellow PDLC layer 630Y, and the cyan PDLC layer 630C may be separated from each another via the barrier ribs 625. The absorption layer 650 is disposed on a bottom surface of the first substrate 612.

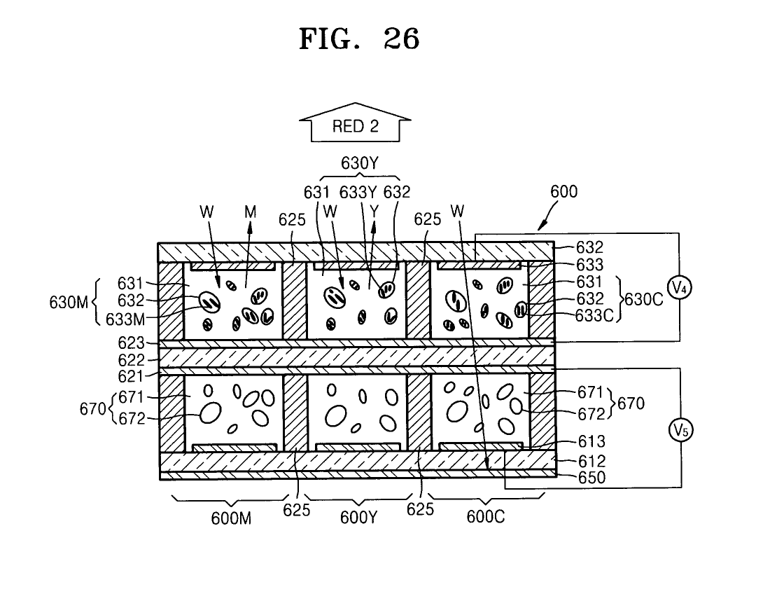

FIGS. 25 and 26 are cross-sectional views illustrating a method of driving the reflective-type display device illustrated in FIG. 24 according to example embodiments.

Referring to FIG. 25, for example, a voltage V₄ is applied between the third and fourth electrodes 623 and 633 that correspond to the cyan sub pixel 600C. The cyan dyes 633C contained in the cyan PDLC layer 630C are arranged to be parallel to an electric field formed between the third electrode 623 and the fourth electrode 63. External white light W, which is incident on the cyan PDLC layer 630C, penetrates the cyan PDLC layer 630C and is subsequently incident on the PDLC layer 670 that is located under the cyan PDLC layer 630C and to which no voltage is applied. The external white light W, which is incident on the PDLC layer 670, is scattered and is subsequently emitted to the outside via the second and third substrates 622 and 632. The external white light W, which is incident on the magenta PDLC layer 630M to which no voltage is applied, is scattered due to the optical characteristics of the polymer 631 and the liquid crystals 632. The dispersed light acts on the magenta dyes 633M, and thus magenta light M is emitted to the outside via the third substrate 632. The external white light W, which is incident on the yellow PDLC layer 630Y, is scattered due to the optical characteristics of the polymer 631 and the liquid crystals 632. The scattered light acts on the yellow dyes 633Y, and thus yellow light Y is emitted to the outside via the third substrate 632. The magenta light M, the yellow light Y and the white light W are respectively emitted from the magenta sub pixel 600M, the yellow sub pixel 600Y and the cyan sub pixel 600C. Thus, the pixel unit 600 assumes red 1.

Referring to FIG. 26, for example, the voltage V₄ is applied between the third and fourth electrodes 623 and 633 that correspond to the cyan sub pixel 600C, and a voltage V₅ is applied between the first and second electrodes 613 and 621 that correspond to the cyan sub pixel 600C. The cyan dyes 633C contained in the cyan PDLC layer 630C are arranged to be parallel to an electric field formed between the third and fourth electrode 623 and 633, and liquid crystal molecules contained in the PDLC layer 670 under the cyan PDLC layer 630C are arranged to be parallel to an electric field between the first and the second electrodes 613 and 621. The external white light W, which is incident on the cyan PDLC layer 630C, penetrates the cyan PDLC, layer 630C and the PDLC layer 670 and is subsequently absorbed by the absorption layer 650. The external white light W, incident on the magenta PDLC layer 630M to which no voltage is applied, is scattered due to the optical characteristics of the polymer 631 and the liquid crystals 632. The scattered light acts on the magenta dyes 633M, and thus magenta light M is emitted to the outside via the third substrate 632. The external white light W incident on the yellow PDLC layer 630Y is scattered due to the optical characteristics of the polymer 631 and the liquid crystals 632. The scattered light acts on the yellow dye 633Y, and thus yellow light Y is emitted to the outside via the third substrate 632. The magenta light M and the yellow light Y are respectively emitted from the magenta sub pixel 600M and the yellow sub pixel 600Y, and the cyan sub pixel 600C assumes black, from which no light is emitted. As such, the pixel unit 600 assumes red 2, which is darker than the red 1 assumed by the pixel unit 500 in FIG. 21.

In the above example embodiments, the pixel unit 600 is described as including the magenta sub pixel 600M, the yellow sub pixel 600Y and the cyan sub pixel 600C but are not limited to the above description and may include various sub pixels. For example, the pixel unit 600 may include a red sub pixel, a green sub pixel and a blue sub pixel.

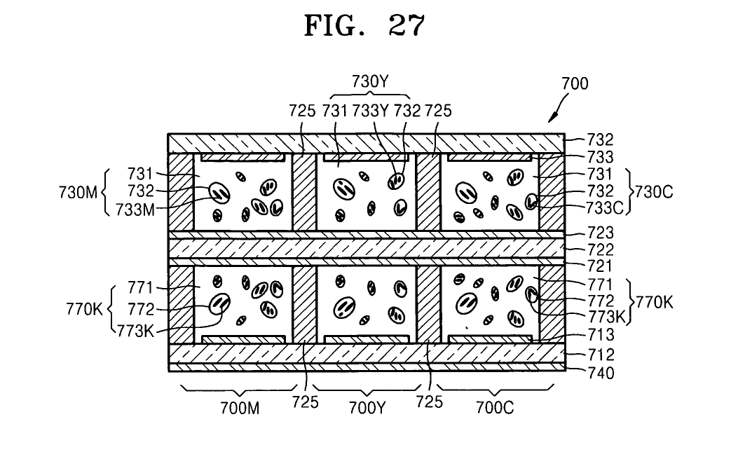

FIG. 27 is a cross-sectional view of a pixel unit 700 included in a reflective-type display device according to example embodiments. The pixel unit 700 illustrated in FIG. 27 will now be described focusing on the differences between the pixel unit 700 and the pixel units 100 to 600 according to the above example embodiments.

Referring to FIG. 27, the pixel unit 700 may include a magenta sub pixel 700M, a yellow sub pixel 700Y and a cyan sub pixel 700C. The pixel unit 700 may include first through third substrates 712, 722 and 732 that are disposed apart from each other. A plurality of first electrodes 713 and a plurality of second electrodes 721 are respectively disposed on the first and second substrates 712 and 722. A plurality of black PDLC layers 770K is disposed between the first electrodes 713 and the second electrodes 721. A plurality of third electrodes 723 and a plurality of fourth electrodes 733 are respectively disposed on the second and third substrates 722 and 732. A magenta PDLC layer 730M, a yellow PDLC layer 730Y and a cyan PDLC layer 730C are disposed between the third electrodes 723 and the fourth electrodes 733. A reflective layer 740 may be disposed on the first substrate 712.

The first through third substrates 712, 722 and 732 may be transparent substrates (e.g., a glass substrate or a plastic substrate). The plurality of the first electrodes 713 are disposed on a top surface of the first substrate 712 and the plurality of the second electrodes 721 are disposed on a bottom surface of the second substrate 722. The plurality of the third electrodes 723 are disposed on a top surface of the second substrate 722 and the plurality of the fourth electrodes 733 are disposed on a bottom surface of the third substrate 732.

The plurality of the black PDLC layers 770K is disposed between the first electrodes 713 and the second electrodes 721 to correspond to the sub pixels 700M, 700Y and 700C. Each of the black PDLC layers 770K may include a polymer 771, liquid crystals 772 dispersed in the polymer 771 and black dyes 773K contained in the liquid crystals 772. The black PDLC layers 770K may be separated from each another via barrier ribs 725. The magenta PDLC layer 730M, the yellow PDLC layer 730Y and the cyan PDLC layer 730C are disposed between the third electrodes 721 and the fourth electrodes 723 to correspond to the sub pixels 700M, 700Y, and 700C. The magenta PDLC layer 730C, the yellow PDLC layer 730Y and the cyan PDLC layer 730C are disposed over the black PDLC layers 770K. The magenta PDLC layer 730M may include a polymer 731, liquid crystals 732 dispersed in the polymer 731, and magenta dyes 733M contained in the liquid crystals 732. The yellow PDLC layer 730Y may include a polymer 731, liquid crystals 732 dispersed in the polymer 731, and yellow dyes 733Y contained in the liquid crystals 732. The cyan PDLC layer 730C may include a polymer 731, liquid crystals 732 dispersed in the polymer 731, and cyan dyes 733C contained in the liquid crystals 732. The magenta PDLC layer 730M, the yellow PDLC layer 730Y and the cyan PDLC layer 730C may be separated from each another via the barrier ribs 725. The reflective layer 740 may be disposed on a bottom surface of the first substrate 712.

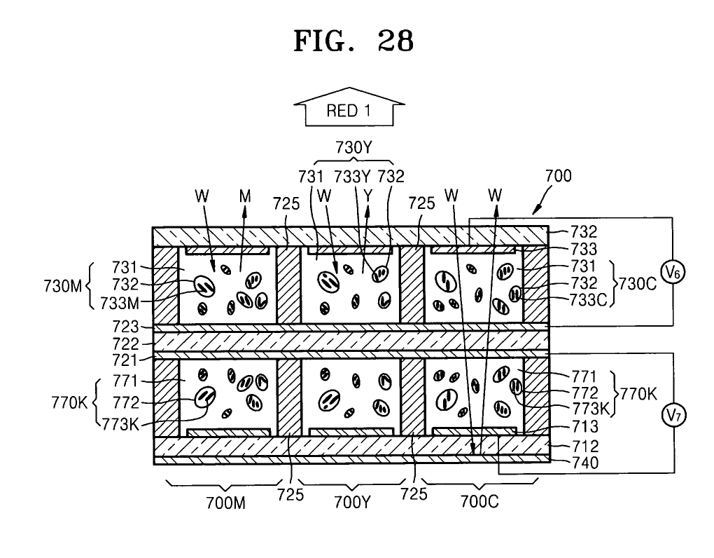

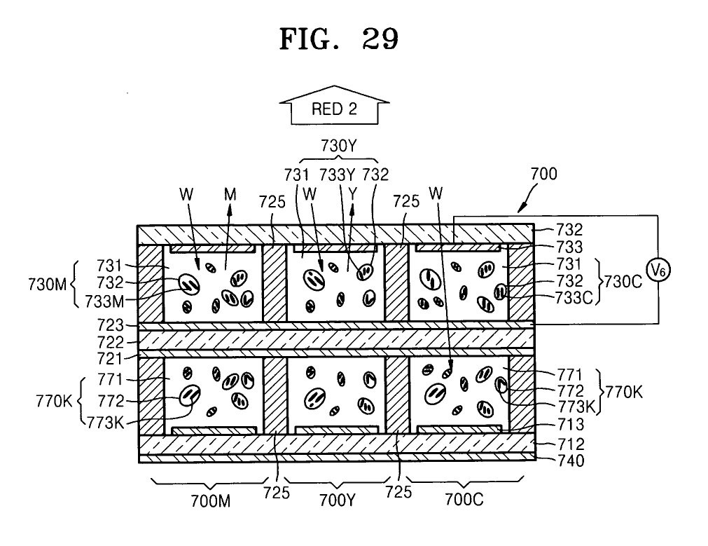

FIGS. 28 and 29 are cross-sectional views illustrating a method of driving the reflective-type display device illustrated in FIG. 27 according to example embodiments.

Referring to FIG. 28, for example, a voltage V₆ is applied between the third and fourth electrodes 723 and 733 that correspond to the cyan sub pixel 700C, and a voltage V₇ is applied between the first and second electrodes 713 and 721 that correspond to the cyan sub pixel 700C. The cyan dyes 733C contained in the cyan PDLC layer 730C are arranged to be parallel to an electric field formed between the third and fourth electrodes 723 and 733, and the black dyes 773K contained in the black PDLC layer 770K under the cyan PDLC layer 730C are arranged to be parallel to an electric field formed between the first and second electrodes 713 and 721. External white light W, incident on the cyan PDLC layer 730C, penetrates the cyan PDLC layer 730C and the black PDLC layer 770K. The penetrated white light W is reflected from the reflective layer 740, and is subsequently emitted to the outside via the second and third substrates 722 and 732. The external white light W, incident on the magenta PDLC layer 730M to no voltage is applied, is scattered due to the optical characteristics of the polymer 731 and the liquid crystals 732. The scattered light acts on the magenta dye 733M, and thus magenta light M is emitted to the outside via the third substrate 732. The external white light W incident on the yellow PDLC layer 730Y is scattered due to the optical characteristics of the polymer 731 and the liquid crystals 732. The scattered light acts on the yellow dye 733Y, and thus yellow light Y is emitted to the outside via the third substrate 732. The magenta light M, the yellow light Y and the white light W are respectively emitted from the magenta sub pixel 700M, the yellow sub pixel 700Y and the cyan sub pixel 700C. As such, the pixel unit 700 assumes red 1.

Referring to FIG. 29, for example, the voltage V₆ is applied between the third and fourth electrodes 723 and 733 that correspond to the cyan sub pixel 700C. The cyan dyes 733C contained in the cyan PDLC layer 730C are arranged to be parallel to an electric field formed between the third electrode 723 and the fourth electrode 733. External white light W, which is incident on the cyan PDLC layer 730C, penetrates the cyan PDLC layer 730C and is then absorbed by the black PDLC layer 770K to which no voltage is applied. The external white light W, which is incident on the magenta PDLC layer 730M to which no voltage is applied, is scattered due to the optical characteristics of the polymer 731 and the liquid crystals 732. The scattered light acts on the magenta dyes 733M, and thus magenta light M is emitted to the outside via the third substrate 732. The external white light W, which is incident on the yellow PDLC layer 730Y, is scattered due to the optical characteristics of the polymer 731 and the liquid crystals 732. The scattered light acts on the yellow dyes 733Y, and thus yellow light Y is emitted to the outside via the third substrate 732. The magenta light M and the yellow light Y are respectively emitted from the magenta sub pixel 700M and the yellow sub pixel 700Y. The cyan sub pixel 700C assumes black, from which no light is emitted. As such, the pixel unit 700 assumes red 2, which is darker than the red 1 assumed by the pixel unit 700 in FIG. 28.

Although in the above example embodiments, the pixel unit 700 is described as including the magenta sub pixel 700M, the yellow sub pixel 700Y and the cyan sub pixel 700C, they are not limited to the above description and may include various sub pixels. For example, the pixel unit 700 may include a red sub pixel, a green sub pixel and a blue sub pixel.

The pixel units according to example embodiments may be used in various display devices including flat display devices such as liquid crystal displays (LCDs), plasma display panels (PDPs) and field emission displays (FEDs).

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A pixel unit, comprising:
a first substrate and a second substrate that apart from each other;
a plurality of first electrodes on the first substrate and a plurality of second electrodes on the second substrate; and
a plurality of different color polymer dispersed liquid crystal (PDLC) layers between the plurality of first electrodes and the plurality of second electrodes, wherein the different color PDLC layers include dyes having a different color than the other PDLC layers,
wherein the pixel unit has a plurality of different color sub pixels.

2. A reflective-type color display device, comprising the pixel unit according to claim 1.

3. The pixel unit of claim 1, further comprising a reflective layer on the first substrate.

4. The pixel unit of claim 3, wherein the first and second substrates are transparent substrates, and the first and second electrodes are formed of a transparent conductive material.

5. The pixel unit of claim 3, wherein the reflective layer is on a bottom surface of the first substrate.

6. The pixel unit of claim 3, wherein the different color dyes are included in at least one selected from the group consisting of a polymer and liquid crystals.

7. The pixel unit of claim 3, wherein the plurality of different color sub pixels includes a magenta sub pixel, a yellow sub pixel and a cyan sub pixel.

8. The pixel unit of claim 3, wherein the plurality of different color sub pixels includes a red sub pixel, a green sub pixel and a blue sub pixel.

9. A reflective-type color display device, comprising the pixel unit according to claim 3.

10. The pixel unit of claim 3, further comprising:
a black PDLC layer between the first electrodes and the second electrodes, wherein the black PDLC layer includes a black dye; and
a reflective layer on the first substrate, wherein the pixel unit includes a black and white sub pixel.

11. The pixel unit of claim 10, wherein the different color dyes and the black dye are included in at least one selected from the group consisting of a polymer, liquid crystals and combinations thereof.

12. The pixel unit of claim 10, wherein the sub pixels of the pixel unit are arranged in at least one line.

13. The pixel unit of claim 10, wherein the plurality of different color sub pixels include a magenta sub pixel, a yellow sub pixel, a cyan sub pixel and the black and white sub pixel.

14. The pixel unit of claim 10, wherein the plurality of different color sub pixels include a red sub pixel, a green sub pixel, a blue sub pixel and the black and white sub pixel.

15. A reflective-type color display device, comprising the pixel unit according to claim 10.

16. The pixel unit of claim 1, further comprising:
an additional PDLC layer between the first electrodes and the second electrodes; and
an absorption layer on the first substrate.

17. The pixel unit of claim 16, wherein the additional PDLC layer corresponds to the black and white sub pixel and includes no dyes.

18. The pixel unit of claim 17, wherein the sub pixels of the pixel unit are arranged in at least one line.

19. A reflective-type color display device, comprising the pixel unit according to claim 16.

20. The pixel unit of claim 1 including at least six of the different color sub pixels.

21. The pixel unit of claim 20, further comprising a reflective layer or an absorption layer on an entire bottom surface of the first substrate.

22. The pixel unit of claim 20, wherein a reflective layer is on a part of a bottom surface of the first substrate that corresponds to some pixels from among the six different color sub pixels, and
an absorption layer is on another part of the bottom surface of the first substrate that corresponds to the other sub pixels from among the six different color sub pixels.

23. The pixel unit of claim 20, wherein the sub pixels are arranged in at least one line.

24. A reflective-type color display device, comprising the pixel unit according to claim 20.

25. The pixel unit of claim 1, further comprising:
a third substrate disposed apart from the first and the second substrate;
a plurality of third electrodes on the second substrate and a plurality of fourth electrodes on the third substrate;
a second plurality of polymer dispersed liquid crystal (PDLC) layers between the third and fourth electrodes; and
an absorption layer on the first substrate.

26. The display device of claim 25, wherein the third electrodes are on a top surface of the first substrate, and the fourth electrodes are on a bottom surface of the second substrate.

27. The display device of claim 26, wherein the first electrodes are on a top surface of the second substrate, and the second electrodes are on a bottom surface of the third substrate.

28. A reflective-type color display device, comprising the pixel unit according to claim 25.

29. The pixel unit of claim 1, further comprising:
a third substrate disposed apart from the first and second substrate;
a plurality of third electrodes on the second substrate and a plurality of fourth electrodes on the third substrate;
a plurality of black polymer dispersed liquid crystal (PDLC) layers between the third and fourth electrodes, wherein the plurality of black PDLC layers include black dye; and
a reflective layer on the first substrate.

30. A reflective-type color display device, comprising the pixel unit according to claim 22.
